(19) United States
(12) Patent Application Publication
(10) Pub. No.: US 2003/0196509 A1
(43) Pub. Date: Oct. 23, 2003

(54) Illuminated gear shift knobs

(76) Inventor: Paul D. Crunk, Taylor, MI (US)

Correspondence Address: PAUL CRUNK, 12220 WOODCREST BOX 725, TAYLOR, MI, 48180, US

(21) Appl. No.: 10/128,051

(22) Filed: Apr. 22, 2002

(51) Int. Cl. B62K 21/12

(52) U.S. Cl. 74/551.8

(57) ABSTRACT

A lighted gear shift knob that can be lighted up during nighttime use to assist the driver easy locate the shifter knob in the dark. The lighted shifter knob can make the job more enjoyable by adding color to the gearshift knob with a simple press of a button. Being able to change the color on the gearshift knob can make the job of the driver more enjoyable. This illuminated gear shift knob is a great show piece at truck stops, truck gatherings, truck shows where driver like to show off their big trucks with many lights inside and outside the vehicles.

### BACKGROUND OF INVENTION

At the present time gearshift knobs used in automobiles or trucks do not have any type of illumination to assist the driver in easily locating the gearshift knob during nighttime hours of usage. Most into gearshift knob are made a black type of plastic material like ABS or other type of plastic material that is hard to see in the dark.

### BRIEF SUMMARY OF THE INVENTION

The present invention provides a visual illumination of the gearshift knob, which the operator can choose the color of their choice from the colors displayed in the gearshift knob. The gearshift knob contains different colors of LED's which the LED's can light up altogether or independently from green, blue, purple, red or any other combination of colors. This can be done using a single LED combination of LED's that can change multiple colors. The present invention the operator can control the pattern in there gearshift knob. With a simple push of a button they can allow the knob to change colors and with a simple press of the button again it can stop on the color of their choice. It is not recommended that the gearshift knob keep change colors as the driver is traveling down the road, which could be distracting to the operator of that vehicle. This changing color feature is intended to be used only to choose a color or it can keep roaming through the colors only when the driver is parked to show off their truck or car.

### BRIEF SUMMARY OF THE INVENTION

The present invention is about having a direct replacement of the gearshift knob using any illuminated LED gearshift knob in its place that helps illuminate the gearshift knob for easy accessibility by the driver and is also a decorative showpiece to add to the interior of the vehicle. The gearshift knob can come in any configuration shape or lighted pattern in which will mount in direct replacement of the standard gearshift knob currently being used in any type of motor vehicle used for on and off the road.

### BRIEF DESCRIPTION OF THE DRAWINGS

FIG. 1 Is showing a simple truck stick shift knob that mounts on top of a valve body assembly mounted to the gear shift shaft connected to the gear box.

FIG. 2 Is showing the top cover of a standard gearshift knob.

FIG. 3 Is showing a LED board with 6 different colored LED that mounts inside the standard gear shift knob.

FIG. 4 Is showing a LED pcb the fits into a LED mounting assembly or can be molded into a gear shift knob.

FIG. 5 Is showing a lighting mounting assembly for the lighted gear shift knobs with On/Off button in the side to turn it on and off or choose the color of choice.

FIG. 6. Is showing a Straight column stick shift knob permimanetely attached where a screw rod is molded into the bottom of the gear shift knob.

FIG. 7 Is showing a screw rod assembly to be molded right into the bottom of a stick shift knob without having to use any mounting screws or other devices to keep it fixed into position.

FIG. 8 Is showing T-shaped shifter knob mounted in a the lighting mounting assembly ready to be screwed onto the stick shift shaft coming from the gear box.

### DETAILED DESCRIPTION OF THE INVENTION

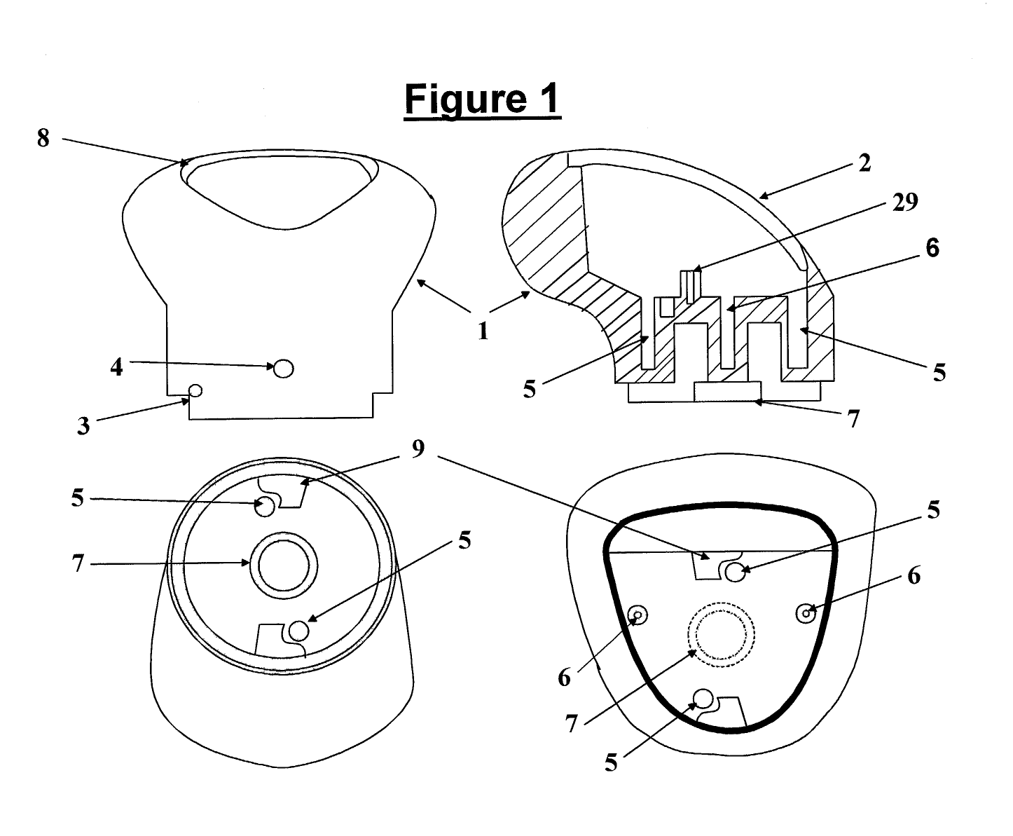

FIG. 1 There are four views of a standard stick shift knob 1 used in most trucks use in the USA today. On the top of the standard knob is placed a cover 2 to cover the top of the knob. On the backside of the standard knob is where the outside wire enters into the standard knob 3 and then is connected to the push button 4, the wires are then connected to the LED PCB board 20 which the LED board then it is screwed down to the inside of the standard knob using two screw holes 6 to securely fix the LED board 20 to the inside of the standard knob. There are also two other holes 5 inside the standard knob to securely fasten the standard knob to the top of the valve body assembly, which is not shown.

The shape of a standard knob is not changing from the original shape, so the new lighted knob can be easily used on many different valve body assembly's they contain different hydraulics and levers for the operator of the vehicle to shift and change gears. As you can see in the drawing that standard knob the shape inside and out of at 9 and 7 remain the same, so therefore the new illuminated knob can mount securely just like the plain standard knob did before on the same valve body assembly. Inside the standard knob is a guide post 29 where the LED board 20 slides over top and is secured using screws to the inside of the standard knob using two the two holes 6 to secure the LED board 20 to the bottom inside of the standard knob. All the components are placed underneath the cover 2 that snaps into place and keeps the components sealed from the outside environment. The cover 2 mounts securely on top of the standard knob 1, which as a groove 8 allows the cover to snap into place to fit flush with the top of the whole knob. In FIG. 2 you can see the LED standard knob top cover 17 from the top view and side view 17 which is the same cover as shown in FIG. 1 number 2 Mounted there on top of the lighted stick shift knob.

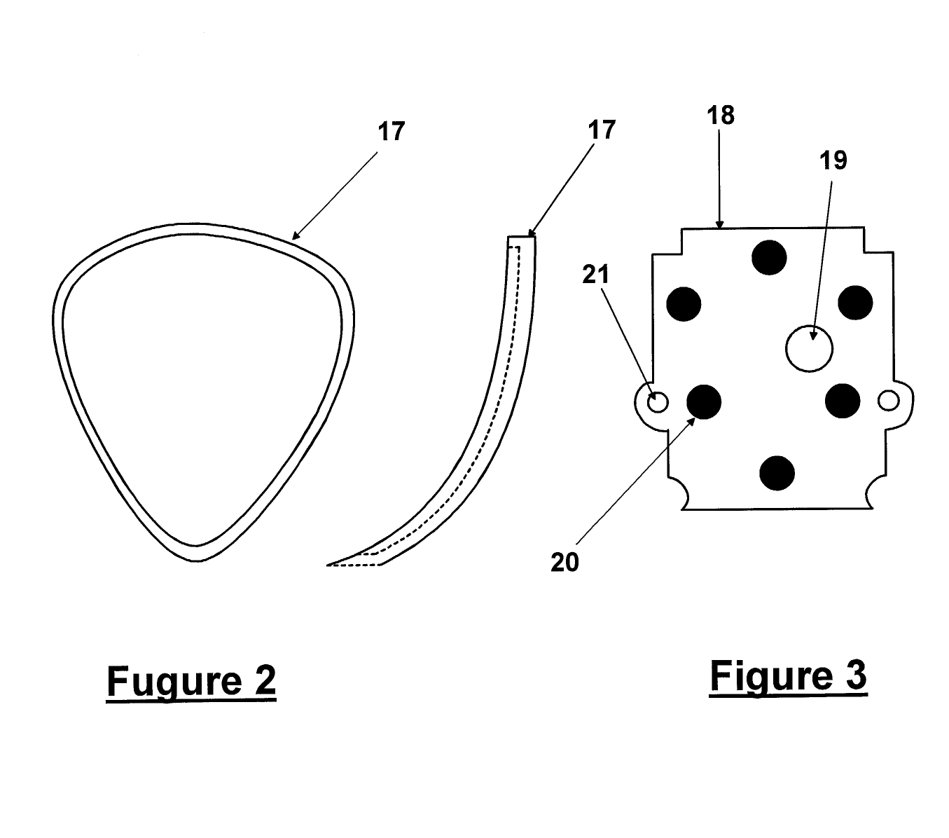

In FIG. 3 is showing the LED board 18 containing six LEDs 20 and the LED PCB you can see two holes 21 for where the LED board is secured to the inside of the knob at 6 and a guide hole 19 allows for easy assembly and also prevents the LED board from shifting side to side wen under vibration.

In FIG. 4 is showing the LED board 10 with six LEDs 15 mounted to the top of the LED board and the LED board 10 having three holes 14 to securely fasten the LED board to the inside of the standard knob 1 using the two inside holes 6 for securing the LED board down to the lighting body assembly

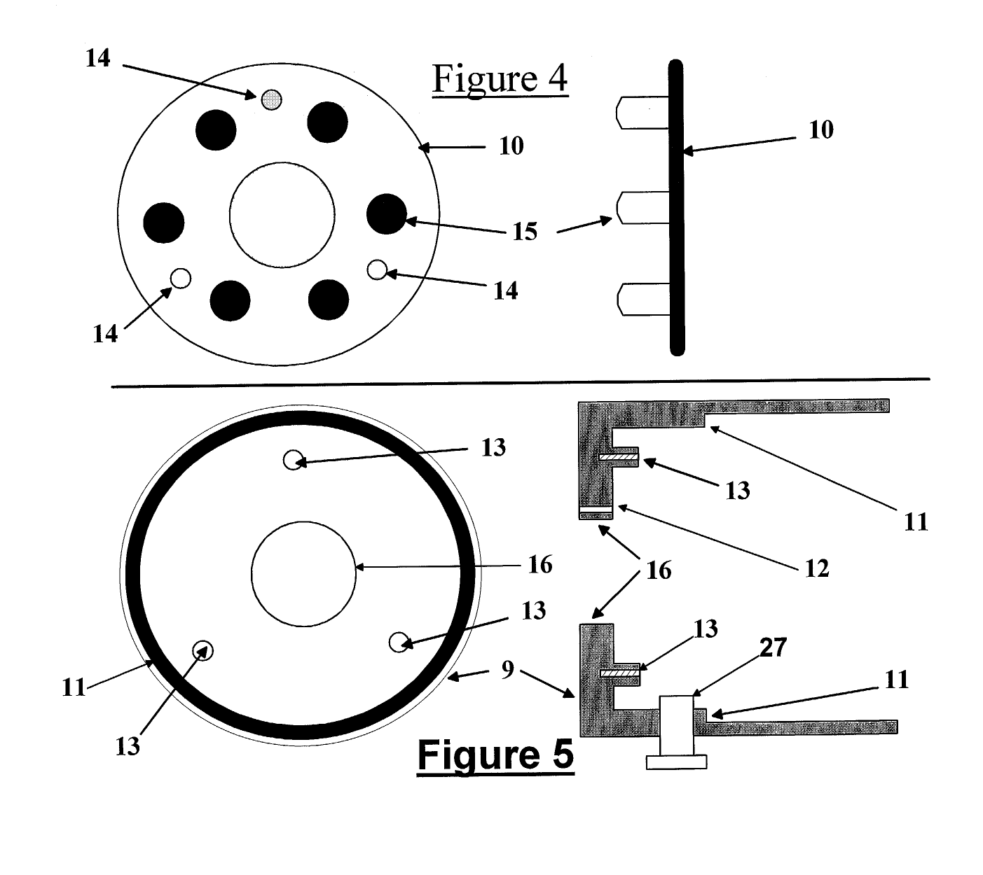

In FIG. 5 is the Lighting body assembly 9 for securing the LED board 10 and the shifter knob 21 or 26 to the inside of the lighting body assembly 9. The lighting body assembly 9 has a step ledge 11 for tightening down the LED knob 21 or 26 tightly to secure the gear shift knob and the lighting body assembly together so they both do not come loose when under vibration. The LED board 10 mounts inside the Lighting body assembly to three riser posts 13 with holes in them using screws to secure the LED board 10 to the bottom of the lighting body assembly 9 on the rider posts.

On the bottom of the lighting body assembly 9. there is a round hole 16 that allows lighting body assembly to screw onto the rod 22 that is currently molded into the LED not knob 21 or 26. You can also see in the Lighting body assembly 9 has a push button switch 27 to be able turn ON and OFF the LED board 10 which is placed inside the Lighting body assembly fixed to the bottom having three holes in 13 which allow three screws to secure the LED board 10 to the bottom for the LED fixture assembly.

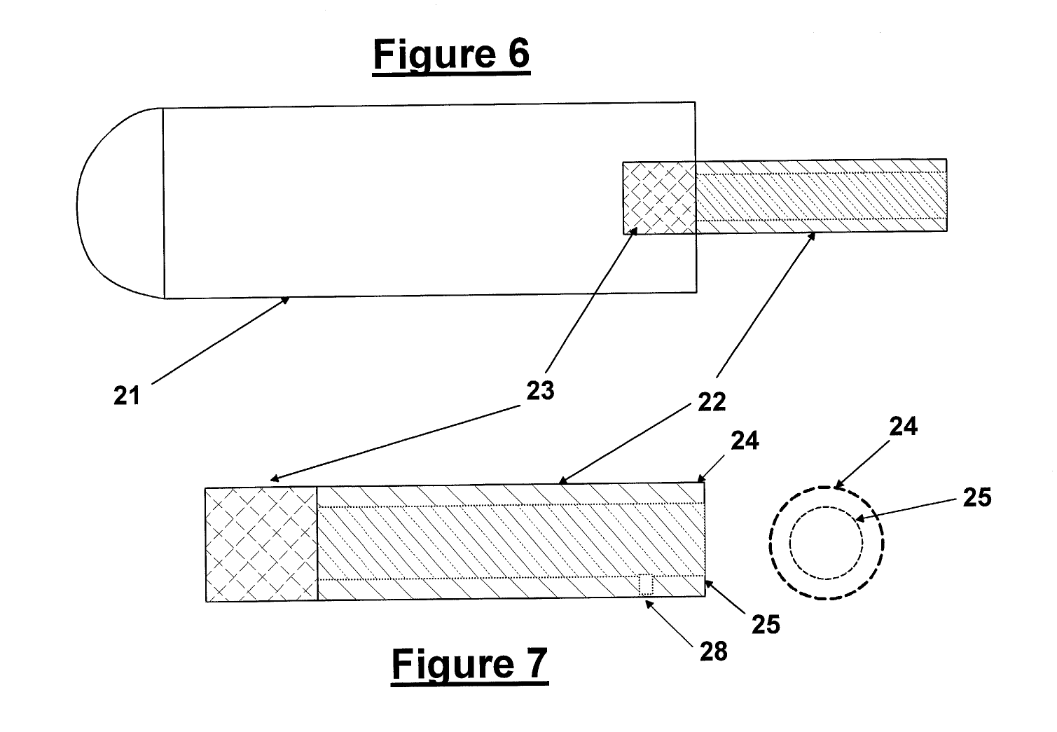

In FIG. 6 You can see the stick shift knob 21 permanently injected or molded to this screw rod, which allows the inside of the shaft 25 being tubular to screw onto the screw provided at the top the stick shift in a vehicle. As you can see on this screw rod, there is also a threaded portion on the exterior of the screw rod that allows the lighting body assembly to screw onto 24 of the screw rod. This screw rod is currently molded into the shifter knob, which at one end of the rod there is a gripper area 23 that securely combines the screw rod and the shifter knob together to make it one piece.

To mount the LED stick shift knob 21 and lighting body assembly to the top portion of the stick shift screw, the screw rod also has a threaded portion 25 inside at one end that allows the user to easily be able to screw the entire assembly onto the top portion of the stick shift in the vehicle. On screw rod shaft 22 has a threaded hole 28 where a small allen screw can be inserted to prevent the screw rod from rotating, vibrating loose when mounted on the top portion of the stick shift.

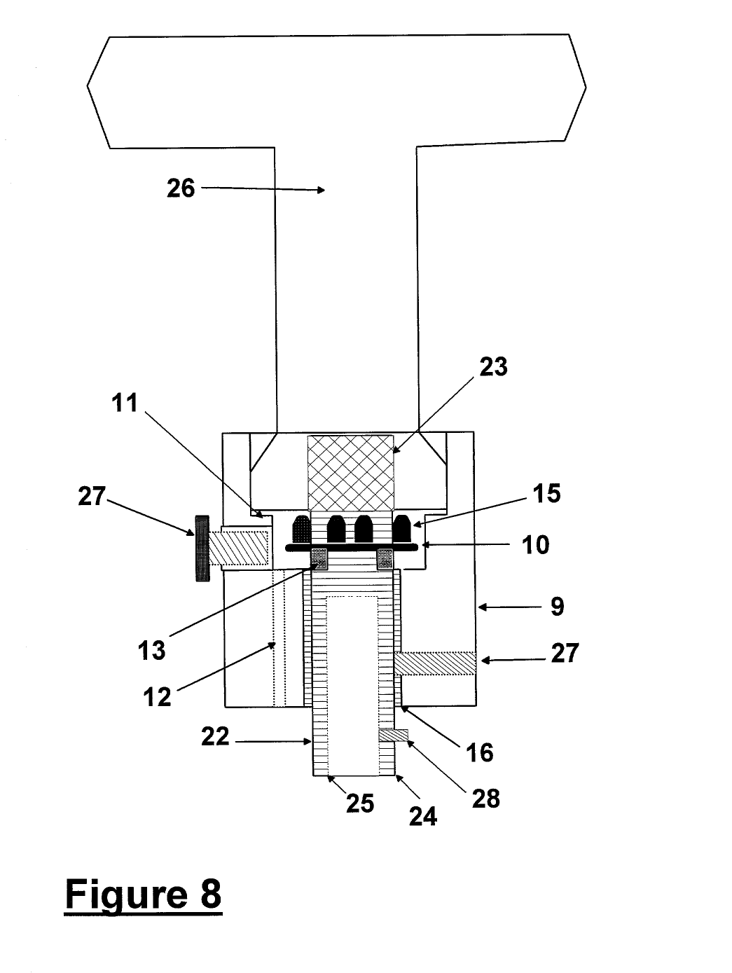

In FIG. 8 You can see the illuminated T-shaped shifter knob assembly 26 fixed to the top portion 23 of the screw rod 22. The screw rod 22 having a threaded OD 24 screws into the lighting body assembly 9 using the inside threaded area 16 in an lighting body assembly 9. For T-shaped shifter knob to be securely tightening down to the inside ledge 11 of the lighting body assembly. The T-shaped shifter knob has the screw rod 22 where there is top area 23 that is molded into the T-shaped shifter knob 26 to make them one-piece. The screw rod 22 is then threaded into the lighting body assembly threaded portion 16 allowing the bottom portion of the T-shaped shifter knob to meet the ledge 17 to allow both pieces to become tightly secured together to become the final assembly. As you can see the LED board 10 being mounted securely on three riser posts 13 off the bottom using one or more LEDs 15, which is positioned under the shifter knob 26 allowing the LED or light bulb light to travel up into the shifter knob 26 to make the shifter knob illuminate. You can also see the lighting body assembly 9 has a push button switch 27 on the side that allows the user easy access to turn on or turn off or choose the color of his or her choice. The same controller switch can also be attached to the lead wire where the lead wire can have a lighter plug for easy hookup. You can also see on the bottom left portion of the lighting body assembly a area for the electrical wire to be able to be run up through the bottom into the lighting body assembly to connect with a push button 27 and the LED board 10 completing the circuit.

In the lighting body assembly it also has a hole on the side for an Allen screw 27 to prevent the LED knob 26 or 21 from rotating in the lighting body assembly. Also you can see on the screw rod 22 has a place for an Allen screw, which prevents the screw rod using the allen screw 27 to keep the screw rod from also turning when mounted on top of the stick shift

What is claimed:

1. An illuminated gearshift knob, which is lighted from within or underneath the gearshift knob using any color or type of lighting source to illuminate the gear shift knob for the purpose of illumination or show.

2. An illuminated gearshift knob of any shape or size or configuration using any number of different colored light bulbs or LED's inside to illuminate the gearshift knob from within or underneath, which can change colors or stop on any single color combination that the user chooses.

3. An illuminated gearshift knob containing a single LED or multiple LEDs, which are capable of changing from one color to another from within the same LED without having to use different colors of LED's to achieve the color effect desired.

4. An illuminated gearshift knob, which is lighted from within where all components are self contained, molded right into the gear shift knob itself, without having to use any other mounting fixtures, and a lighter plug can be attached to the end of a long cord for easy hook up to a power source.

5. An illuminated gearshift knob, which is lighted from within or underneath, where some or all the components are mounted in the lighting body assembly. The stick shift knob is then mounted into the lighting body assembly where the lighting body assembly is then mounted securely on top of the stick shift which is connected to the vehicle gear box. The same lighting body also contains a control button as is part of the lighting body assembly with cord coming out of the lighting body assembly where at the end of the cord can be connected to an optional lighter plug for easy assembly and hook up to a power source.

6. An illuminated gearshift knob lighted from within or underneath, where some or all the components are mounted in the lighting body assembly. The lighting body assembly then mount to the top of the stick shift shaft, where the controller button is attached to the end of the power cord an optional lighter plug for easy assembly and hook up to a power source.

7. An illuminated gearshift knob, which is lighted from within or underneath where the shifter knob, the lighting body assembly or screw rod has a hole for an allen type screw fastener for keeping the shift knob or assembly from rotating or coming loose when mounted.
